(19) United States
(12) Patent Application Publication
(10) Pub. No.: US 2020/0019625 A1
(43) Pub. Date: Jan. 16, 2020

(54) VRH On-demand, fine-grain, incremental-integration of on-site storage content with remote compute and storage resources method, system, and apparatus

(71) Applicants: Roger March, Santa Clara, CA (US); Siarhei Malchankou, San Jose, CA (US); Shivinder Singh Sikand, Campbell, CA (US)

(72) Inventors: Roger March, Santa Clara, CA (US); Siarhei Malchankou, San Jose, CA (US); Shivinder Singh Sikand, Campbell, CA (US)

(21) Appl. No.: 16/034,760

(22) Filed: Jul. 13, 2018

(51) Int. Cl. G06F 17/30

(52) U.S. Cl. CPC G06F 17/30194

(57) ABSTRACT

A remote accessor apparatus captures a state of an existing data store and exports the state to a hosted projected data store. When a file operation interceptor apparatus receives a request, it determines whether it requires a transmission from the existing data store or it can be fulfilled locally. An operation controller combines local and transmitted data to fulfill the requested file operation and stores the difference locally. On-demand, read/write requests are intercepted and fulfilled by a combination of locally provisioned file content operations and remote access requests to the agent apparatus in whole or in part. Upon first request, file contents are transferred to meet application need but are then retained for other users and other uses. Upon request, a new state for the existing data store is provided by combining archived data with local file operations.

### CROSS-REFERENCE TO RELATED APPLICATIONS

None.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### Technical Field

The disclosure relates improving the efficiency of networked storage systems in time and space.

Background: Referring now to the figures, both FIG. 1A and FIG. 1B illustrate a multi-site data storage and compute configuration. A (legacy or otherwise) data store 111 is a collection of files and their meta-data. This could a traditional file system (native, NFS, CIES), an object store (53) or something eke (git, OA). This is typical of on premises resources of a data and compute intensive enterprise.

A projected data store 181 is a virtualization of said data store 111 in that it emulates behavior without having the same physical structure. This is modernized by utilizing cloud services. But it could simply be two private data centers communicatively coupled.

A database 191 is anything that can provide at least {key,value} semantics. For the purpose of the present patent application it may be logically constructed of any one of conventional database technologies on any physical non-transitory media operated by a cloud service provider.

### BRIEF SUMMARY OF INVENTION

The invention is a system (Virtual Remote Holodeck) which includes a file operation request interceptor, a controller, and an accessor. These couple a 1^{st} data store, a database situated away from the 1^{st} data store, and a projected data store which is a virtualization of said 1^{st} data store.

In the method of the invention, when a program makes a file request, for example a file read, an interceptor analyzes the request with respect to meta data of a projected data store and calls a controller to satisfy it as follows. In the case of a read it first looks in the database to see if it can be completed in whole or in part with the information already stored there. For any part that cannot be satisfied within the cloud service, the controller makes a request of the accessor for the missing parts. The accessor will get what is needed from the legacy data store on premises and send it to back to the controller. The controller will store this new information into the database for future use. It then assembles everything needed for the originating request and send it back to the interceptor to complete the operation.

A remote accessor apparatus captures a state of an existing data store and exports the state to a hosted projected data store. When a file operation interceptor apparatus receives a request, it determines whether it requires a transmission from the existing data store or it can be fulfilled locally. An operation controller combines local and transmitted data to fulfill the requested file operation and stores the difference locally. On-demand, read/write requests are intercepted and fulfilled by a combination of locally provisioned file content operations and remote access requests to the agent apparatus in whole or in part. Upon first request, file contents are transferred to meet application need but are then retained for other users and other uses.

Upon request, a new state for the existing data store is provided by combining archived data with local file operations. In a further improvement, the system returns only changed items to the 1^{st} data store upon request, whereby unnecessary data communication is minimized.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIGS. 1A and 1B are block diagrams of two embodiments of a system;

FIG. 2 is flow chart of processes performed at various subsystems of the invention, the accessor, interceptor, and controller;

FIGS. 3-5 are block diagrams of apparatus embodiments of accessor, interceptor, and controller; and

FIG. 6 is a block diagram of a processor suitable for performing a method embodiment of the invention.

### DETAILED DESCRIPTION OF INVENTION

As is known, cloud-based services for data and compute scale attractively and dynamically respond to varying requirements. However, wholesale transfer of large datasets related to enterprise level projects are inefficient and uneconomical. And even piecemeal uploading and downloading of file systems is frustrated by undocumented dependencies and limited bandwidth.

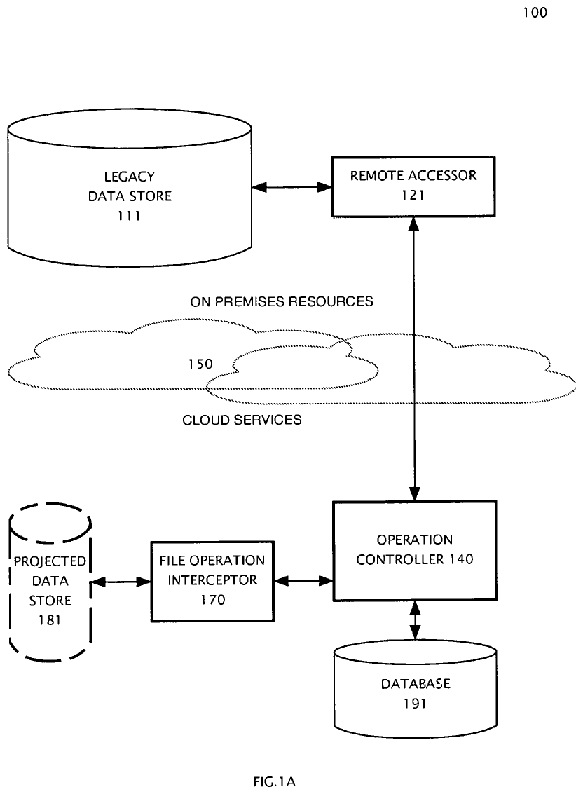

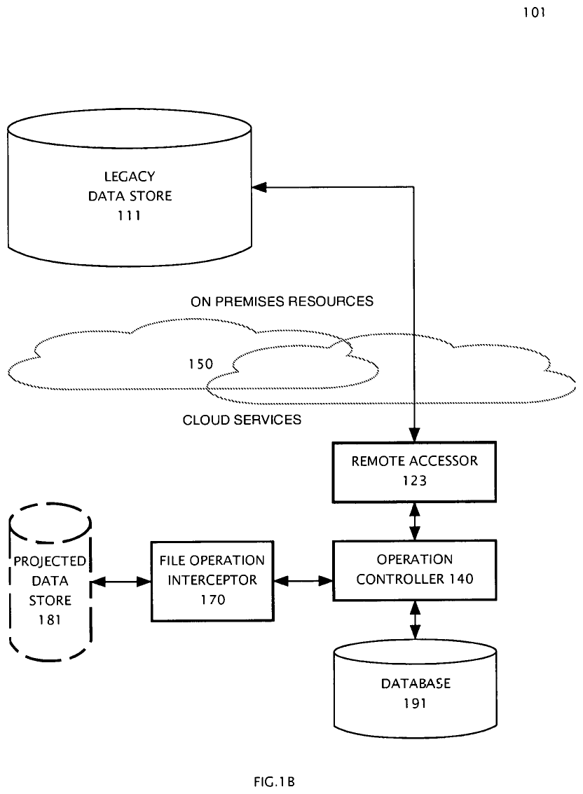

One aspect of the invention shown in FIG. 1A and FIG. 1B are systems 100 and 101. In an embodiment, a first Remote Accessor 121 is directly coupled to a Legacy Data Store 111. In an embodiment, a second Remote Accessor 123 is coupled via a network 150 to a Legacy Data Store 111. In an embodiment said Remote Accessor 121 is communicatively coupled by a network 150 to an Operation Controller 140. In an embodiment, said Remote Accessor 123 is directly coupled to said Operation Controller 140.

In systems 100 and 101, said Operation Controller 140 is further coupled to a Database 191 and to a File Operation Interceptor 170. The File Operation Interceptor is further enabled to read the stored projected data store 181 which tracks the state of the contents of the Legacy Data Store 111. The File Operation Interceptor receives file operation requests and fulfills them.

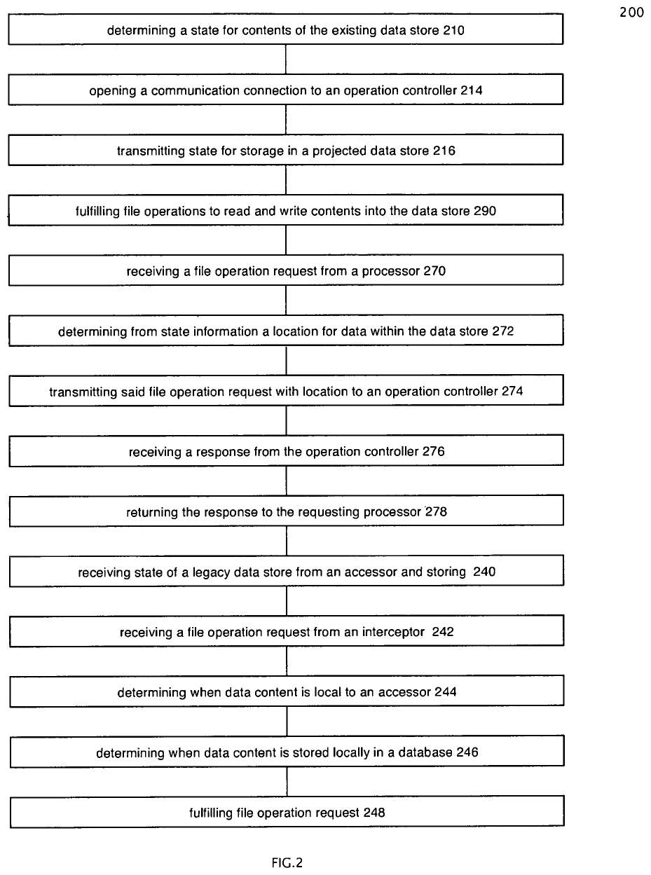

Another aspect of the invention shown in FIG. 2 is flowchart 200 of processes in a method embodiment of the invention.

At a remote accessor apparatus, the method 200 comprises: determining a state for contents of the existing data store 210; opening a communication connection to an operation controller 214; transmitting state for storage in a projected data store 216, and fulfilling file operations requested by the operation controller to read and write contents into the data store 290.

At a file operation interceptor, the method 200 comprises: receiving a file operation request from a processor 270; determining from state stored in the projected data store a location for data within the data store 272; transmitting said file operation request with location to an operation controller 274; receiving a response from the operation controller 276; and returning the response to the requesting processor 278.

At an operation controller, the method 200 comprises: receiving state of a legacy data store from an accessor and storing it non-transitory computer-readable media 240; receiving a file operation request from an interceptor 242; determining when data content is local to an accessor 244; determining when data content is stored locally in a database 246; combining and transmitting data content in fulfillment of the file operation request 248.

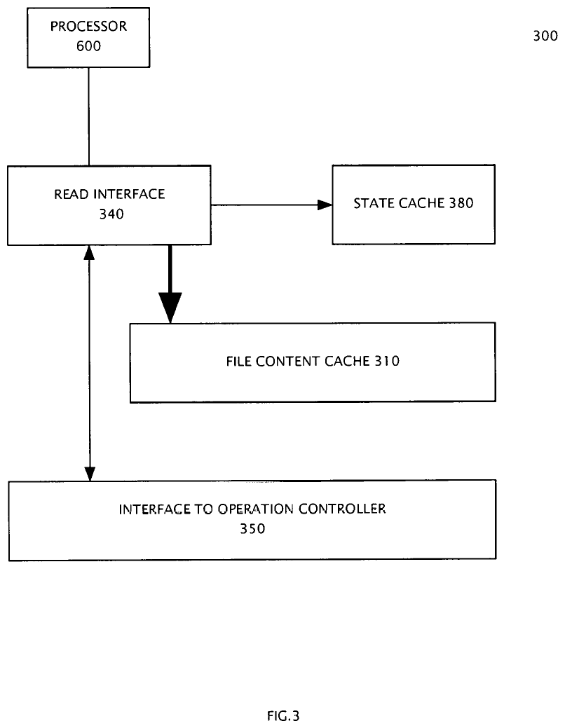

FIG. 3 is an exemplary block diagram of an embodiment of a remote accessor apparatus. It gathers information about the state of the existing or legacy data store. It may be located on-prem or in the cloud. It forwards the state information to the operation controller and ultimately to the projected data store image available to the file operation interceptor. In addition, it retrieves file content requested by the operation controller out of the data store. The remote accessor apparatus has a processor 600. It has a read interface to the data store. 340, It has a state cache 380, an interface to an operation controller 350, and a file content cache 310.

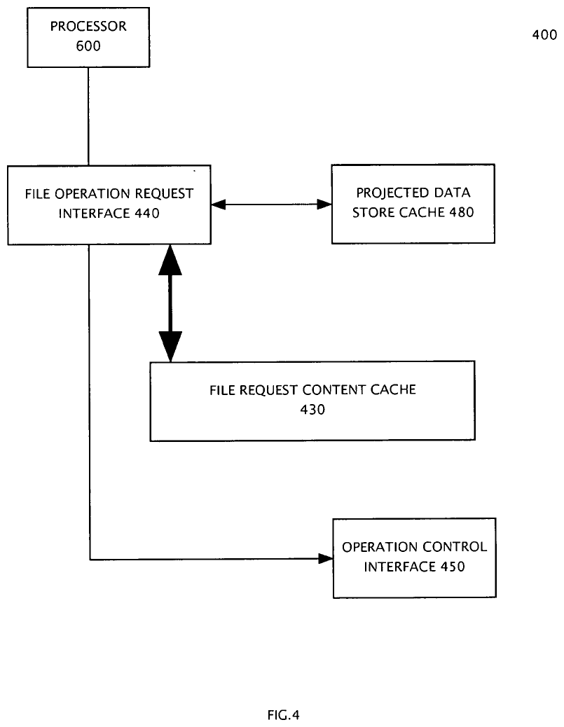

FIG. 4 is an exemplary block diagram of an embodiment of a file operation interceptor apparatus. It enables a program to access the projected data store. This can be implemented through a virtual file system (FUSE), a library complied into a program, and interposer library or in an embodiment, a circuit. The file operation interceptor apparatus 400 includes a processor 600, a file operation request interface 440, a projected data store cache 480, a file request content cache 430, and an operation control interface 450. A program is unconscious of its location and makes file read and file write operation requests as if it were attached to the legacy data store and references these location via the projected data store. The file operation interceptor hides the reality that writes will be into the local database and reads will only access the legacy data store when it cannot be entirely fulfilled from content written into the local database.

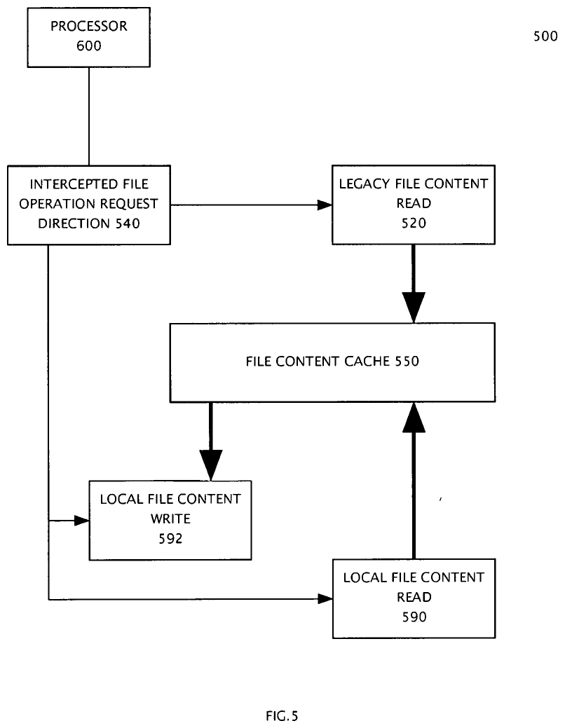

FIG. 5 is an exemplary block diagram of an embodiment of an operation controller apparatus. It is responsible for taking intercepted requests and figuring out how to satisfy the requests through some combination of operations to the database or the remote accessor. The operation controller apparatus 500 includes a processor 600, a legacy file content read circuit 520 communicatively coupled to a remote accessor 520, a local file content read circuit 590 coupled to a database, a local file content write circuit 592 coupled to the database, a file content cache 550, and an intercepted file operation request direction circuit 540. Every intercepted file write operation causes the content cache to be written into locally into the database. Intercepted file read operations may consist of one of the following: file content which has been written into the local database, file content which must be retrieved via the remote accessor from the legacy data store, and a combination of the two previous cases. File content which has been retrieved via the remote accessor once is then stored locally and, thus, never is retrieved again from the remote accessor. When the file content cache contains the requested file read content, the intercepted file read operation is fulfilled.

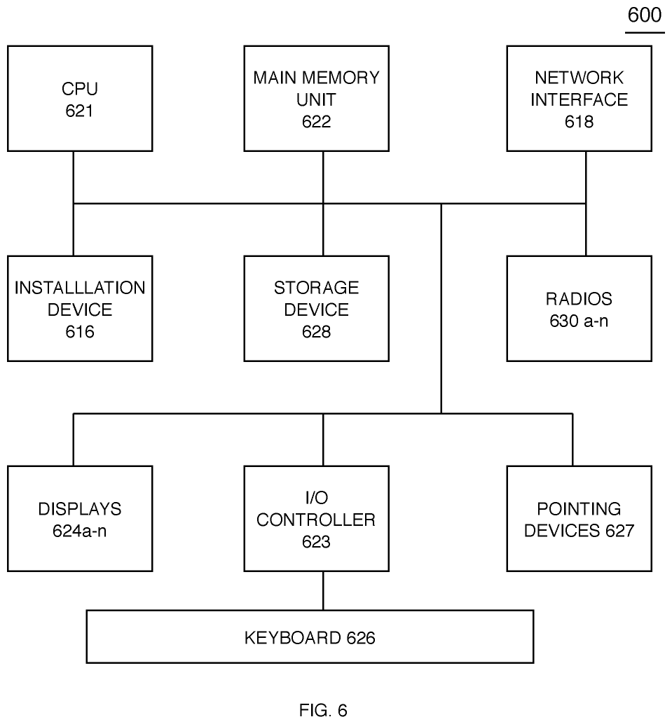

FIG. 6 is a block diagram of an exemplary processor 600 configured by computer executable instructions encoded in non-transitory media to perform the steps, transformations, and decision processes of a method embodiment of the invention.

Aspects of the invention can be appreciated as methods, apparatuses, and systems combining such methods and apparatuses.

One aspect of the invention is a system including: a projected data store; coupled to, a file operation interceptor; coupled to, an operation controller; and said operation controller coupled to, a database.

In an embodiment, the system includes a remote accessor; coupled to the operation controller, and remotely coupled via a network to a legacy data store whose state is known to the projected data store.

In an embodiment, the system includes a remote accessor; directly coupled to a legacy data store, and remotely coupled via a network to the operation controller.

Another aspect of the invention is a method performed by a remote accessor including: determining a state for contents of the existing data store; opening a communication connection to an operation controller; transmitting state for storage in a projected data store; and fulfilling file operations requested by the operation controller to read and write contents into the data store.

Another aspect of the invention is a method performed by a file operation interceptor including: receiving a file operation request from a processor; determining from state stored in the projected data store a location for data within the data store; transmitting said file operation request with location to an operation controller; receiving a response from the operation controller; and returning the response to the requesting processor.

Another aspect of the invention is a method performed by a file operation controller including the processes: receiving state of a legacy data store from an accessor and storing it non-transitory computer-readable media; receiving a file operation request from an interceptor; determining when data content is local to an accessor; determining when data content is stored locally in a database; and combining and transmitting data content in fulfillment of the file operation request.

### CONCLUSION

Thus, it can be appreciated that the present invention can be easily distinguished by allowing an existing data store to be remotely projected efficiently in time and space into another site either cloud or on-prem.

The present invention can be easily distinguished by a remote accessor apparatus capturing a state of an existing data store and exporting the state to a hosted projected data store.

The present invention can be easily distinguished by a file operation interceptor apparatus, upon receiving a request, determining whether it requires a transmission from the existing data store or it can be fulfilled locally.

The present invention can be easily distinguished by a file operation controller combining local and transmitted data to fulfill a requested file operation and storing the difference locally.

On-demand, read/write requests are intercepted and fulfilled by a combination of locally provisioned file content operations and remote access requests to the agent apparatus in whole or in part. Upon first request, file contents are transferred to meet application need but are then retained for other users and other uses. Upon request, a new state for the existing data store is provided by combining archived data with local file operations.

As is known, circuits disclosed above may be embodied by programmable logic, field programmable gate arrays, mask programmable gate arrays, standard cells, and computing devices limited by methods stored as instructions in non-transitory media.

Generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; or Alphabet of Mountain View Calif. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment’, in another embodiment’, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for video surveillance, it will now become apparent to one of skill in the art that other embodiments incorporating the concepts of the disclosure may be used. Therefore, the disclosure should not be limited to certain embodiments, but rather should be limited only by the spirit and scope of the following claims.

We claim:

1. A system comprising:
a projected data store; coupled to,
a file operation interceptor; coupled to,
an operation controller; and said operation controller coupled to,
a database.

2. The system of claim 1 further comprising:
a remote accessor; coupled to the operation controller, and remotely coupled via a network to a legacy data store whose state is known to the projected data store.

3. The system of claim 1 further comprising:
a remote accessor; directly coupled to a legacy data store, and remotely coupled via a network to the operation controller.

4. A method performed by a remote accessor comprising:
determining a state for contents of the existing data store;
opening a communication connection to an operation controller;
transmitting state for storage in a projected data store; and
fulfilling file operations requested by the operation controller to read and write contents into the data store.

5. A method performed by a file operation interceptor comprising:
receiving a file operation request from a processor;
determining from state stored in the projected data store a location for data within the data store;
transmitting said file operation request with location to an operation controller;
receiving a response from the operation controller; and
returning the response to the requesting processor.

6. A method performed by a file operation controller comprising the processes:
receiving state of a legacy data store from an accessor and storing it non-transitory computer-readable media;
receiving a file operation request from an interceptor;
determining when data content is local to an accessor;
determining when data content is stored locally in a database; and
combining and transmitting data content in fulfillment of the file operation request.
